(19) United States
(12) Patent Application Publication
(10) Pub. No.: US 2021/0126390 A1
(43) Pub. Date: Apr. 29, 2021

(54) TERMINAL FITTING

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Katsuhiko AIZAWA, Yokkaichi (JP); Akihiro HAYASHI, Yokkaichi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/756,691

(22) PCT Filed: Oct. 19, 2018
(86) PCT No.: PCT/JP2018/039017

§ 371 Date: Apr. 16, 2020

(30) Foreign Application Priority Data
Oct. 24, 2017 (JP) 2017-204963

(51) Int. Cl. H01R 12/72; H01H 1/06; H01R 13/02

(52) U.S. Cl. CPC H01R 12/72; H01R 13/02; H01H 1/06

(57) ABSTRACT

A terminal fitting to be connected to a mating terminal in a form of a flat plate, the terminal fitting including: a body including a pair of side walls arranged to face each other and a coupling wall coupling the pair of side walls and capable of accommodating the mating terminal inside; and an obliquely wound coil spring arranged along the coupling wall inside the body, electrically connected to the body and configured to resiliently contact the mating terminal accommodated inside the body.

### BACKGROUND

A technique disclosed by this specification relates to a terminal fitting.

A power supply device to be installed in an electric or hybrid vehicle includes a battery pack formed by combining a plurality of unit cells and a casing for accommodating this battery pack. A connector fitting chamber in which a male terminal electrically connected to the battery pack is arranged inside is provided in the casing, and the power supply device is connected to an external device by fitting a mating connector housing into this connector fitting chamber (see Japanese Unexamined Patent Publication No. 2017-54588).

### SUMMARY

When maintenance or exchange is made, the power supply device needs to be removed from a vehicle body. For example, if the power supply device is installed in a lower part of a vehicle body, a worker needs to get under the vehicle body and remove the connector housing from the power supply device. Thus, a workload is large.

A terminal fitting disclosed by this specification is a terminal fitting to be connected to a mating terminal in the form of a flat plate, the terminal fitting includes a body having a pair of side walls arranged to face each other and a coupling wall coupling the pair of side walls and capable of accommodating the mating terminal inside, and a contact arranged along the coupling wall inside the body, electrically connected to the body and configured to resiliently contact the mating terminal accommodated inside the body, wherein one side wall of the pair of side walls includes an insertion opening, the mating terminal being inserted into the body through the insertion opening, and the other side wall of the pair of side walls includes a withdrawal opening, the mating terminal being withdrawn from the body through the withdrawal opening.

According to the above configuration, in connecting the mating terminal to the terminal fitting, the mating terminal may be inserted into the body through the insertion opening by being slid in parallel to the coupling wall. Further, in separating the mating terminal from the terminal fitting, the mating terminal may be withdrawn to the outside of the body through the withdrawal opening by being similarly slid in parallel to the coupling wall. The mating terminal can be easily inserted into and withdrawn from the terminal fitting by being slid in this way. Thus, a workload can be reduced also when a worker has to perform an operation in a somewhat uncomfortable posture such as when the worker gets under a vehicle body to perform an operation.

In the above configuration, the contact may be a coiled obliquely wound coil spring formed by winding a conductive wire material a plurality of times such that the wire material is inclined in one direction with respect to an axis line, and the obliquely wound coil spring may be arranged in contact with the coupling wall in such an orientation that the axis line is parallel to the coupling wall.

Further, the obliquely wound coil spring may be arranged such that the axis line is perpendicular to the pair of side walls and the wire material is inclined in a direction to approach the other side wall from the one side wall with distance from the coupling wall.

According to these configurations, in inserting the mating terminal into the body through the insertion opening, the obliquely wound coil spring is tilted and deformed to reduce a spring height (dimension in a direction perpendicular to the axis line). In this way, the mating terminal can be inserted with a low insertion force. Further, also in withdrawing the mating terminal to the outside of the body through the withdrawal opening, a force acts from the mating terminal on the obliquely wound coil spring in a direction to reduce the spring height (dimension in the direction perpendicular to the axis line). Thus, the mating terminal can be withdrawn with a low withdrawal force.

In the above configuration, the contact may be a resilient contact piece in the form of a leaf spring continuous from the coupling wall n and extending along the coupling wall.

In the above configuration, the body may include a pair of the coupling walls and a pair of the contacts arranged to face each other.

According to these configurations, the mating terminal is sandwiched by the pair of contacts if the mating terminal is inserted into the terminal fitting. In this way, the contacts can be brought into contact with the mating terminal with a constant contact pressure and the reliability of electrical connection of the terminal fitting and the mating terminal can be enhanced.

According to the terminal fitting disclosed by this specification, a workload can be reduced.

### BRIEF DESCRIPTION OF THE DRAWINGS

FIG. 1 is a perspective view showing a state before a tab portion is inserted into a female terminal fitting in a first embodiment,

FIG. 2 is a perspective view showing a state where the tab portion is inserted in the female terminal fitting in the first embodiment,

FIG. 3 is a front view showing the state where the tab portion is inserted in the female terminal fitting in the first embodiment,

FIG. 4 is a perspective view showing a state where the tab portion is withdrawn from the female terminal fitting in the first embodiment,

FIG. 5 is a front view of the female terminal fitting of the first embodiment,

FIG. 6 is a side view of an obliquely wound coil spring,

FIG. 7 is a side view of a general coil spring,

FIG. 8 is a perspective view showing a state before a tab portion is inserted into a female terminal fitting in a second embodiment,

FIG. 9 is a perspective view showing a state where the tab portion is inserted in the female terminal fitting in the second embodiment,

FIG. 10 is a front view showing the state where the tab portion is inserted in the female terminal fitting in the second embodiment,

FIG. 11 is a perspective view showing a state where the tab portion is withdrawn from the female terminal fitting in the second embodiment, and

FIG. 12 is a front view of the female terminal fitting of the second embodiment.

### DETAILED DESCRIPTION OF EMBODIMENTS

### First Embodiment

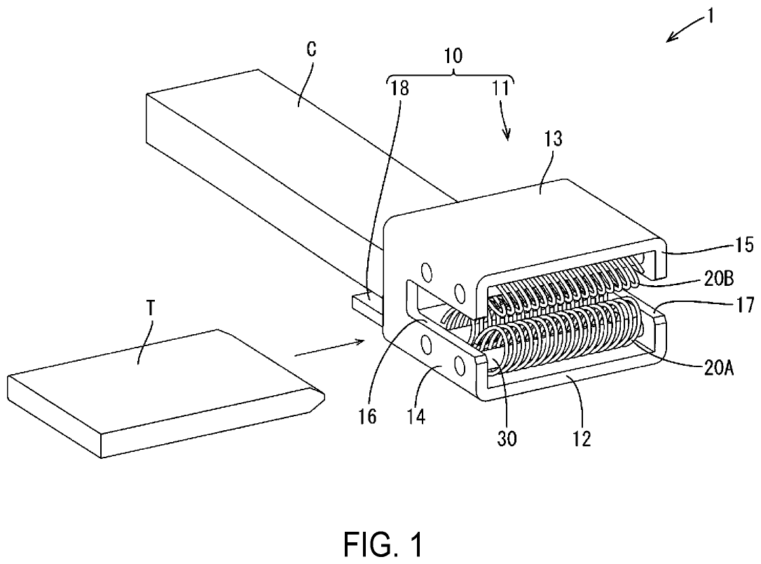

A first embodiment is described with reference to FIGS. 1 to 7. A terminal fitting of this embodiment is a female terminal fitting 1 connected to a wire extending from a device installed in a vehicle. This female terminal fitting 1 is connected to a male terminal fitting provided in a power storage device installed in the vehicle. The male terminal fitting includes a tab portion T in the form of a flat plate. Only the tab portion T is schematically shown for the male terminal fitting with other parts omitted in FIGS. 1 to 4.

As shown in FIG. 1, the female terminal fitting 1 includes a terminal body 10 made of metal and four obliquely wound coil springs 20 (corresponding to a contact portion) held in this terminal body 10 by four holding shafts 30.

As shown in FIG. 1, the terminal body 10 includes a rectangular tube portion 11 (corresponding to a body portion or body) for receiving the tab portion T of the male terminal fitting inside and a wire connecting portion 18 continuous from this rectangular tube portion 11.

As shown in FIG. 1, the rectangular tube portion 11 is a part having a rectangular tube shape open on both ends, and includes a bottom wall portion 12, a ceiling wall portion 13 and a pair of side wall portions (or side walls) (first side wall portion 14 and second side wall portion 15). The pair of side wall portions 14, 15 are rectangular plate-like parts arranged to face each other. The bottom wall portion 12 is a rectangular plate-like part coupling the pair of side wall portions 14, 15. The ceiling wall portion 13 is a rectangular plate-like part arranged to face the bottom wall portion 12 and coupling the pair of side wall portions 14, 15.

The first side wall portion 14 includes an insertion slit 16 (corresponding to an insertion opening) serving as an entrance for the tab portion T, and the second side wall portion 15 includes a withdrawal slit 17 (corresponding to a withdrawal opening) serving as an exit for the tab portion T. The insertion slit 16 is arranged at a middle position between the bottom wall portion 12 and the ceiling wall portion 13, and extends parallel to the bottom wall portion 12 and the ceiling wall portion 13 from one opening edge (opening edge on a front side of FIG. 1) of the rectangular tube portion 11 to the vicinity of the other opening edge (opening edge on a back side of FIG. 1). The withdrawal slit 17 is similar to the insertion slit 16. Slit widths of the insertion and withdrawal slits 16, 17 are somewhat larger than a thickness of the tab portion T, and the tab portion T can be inserted into and withdrawn from the rectangular tube portion 11 through the insertion and withdrawal slits 16, 17.

As shown in FIG. 1, the wire connecting portion 18 is a flat plate-like part continuous from the bottom wall portion 12 and, for example, a core C of the wire is connected by resistance welding.

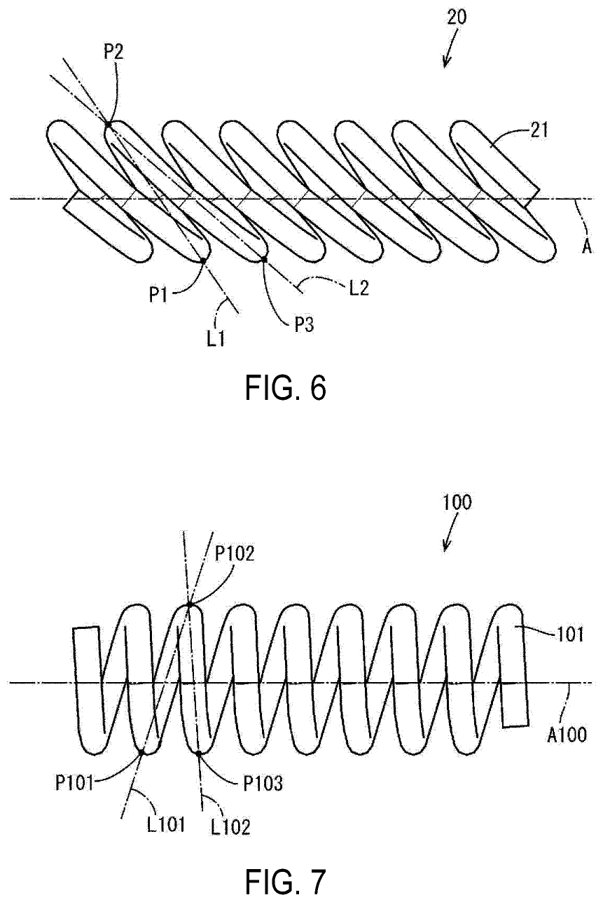

The obliquely wound coil spring 20 is in the form of a coil formed by winding a conductive wire material 21 a plurality of times. In this obliquely wound coil spring 20, the wire material 21 is wound to be inclined in one direction with respect to a coil axis A (corresponding to an axis line) unlike in a general coil spring 100. In the general coil spring 100 shown in FIG. 7, a straight line L101 connecting an arbitrary point P101 of a wire material 101 and a point P102 distant from the arbitrary point P101 by a half circumference and a straight line L102 connecting the point P102 and a point P103 distant from the point P2 by a half circumference are inclined toward opposite sides with respect to a coil axis A100. In contrast, in the obliquely wound coil spring 20 shown in FIG. 6, a straight line L1 connecting an arbitrary point P1 of the wire material 21 and a point P2 distant from the arbitrary point P1 by a half circumference and a straight line L2 connecting the point P2 and a point P3 distant from the point P2 by a half circumference are inclined toward the same side with respect to the coil axis A.

The obliquely wound coil spring 20 thus configured is so deformed that winding is tilted to reduce a spring height (dimension in a direction perpendicular to the coil axis A) if a load is applied to the coil axis A in a perpendicular direction.

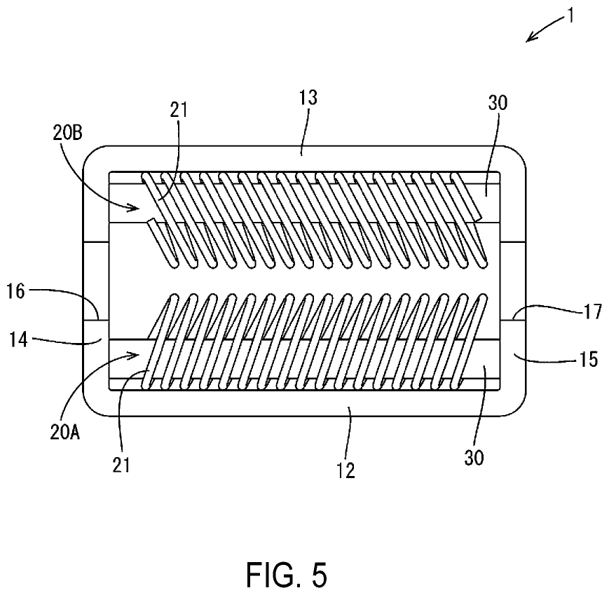

Each of the four obliquely wound coil springs 20 is arranged in such an orientation that the coil axis A is parallel to the bottom wall portion 12 and the ceiling wall portion 13 and perpendicular to the pair of side wall portions 14, 15 as shown in FIGS. 1 and 5. Two of the four obliquely wound coil springs 20 are arranged along the bottom wall portion 12, and the other two are arranged along the ceiling wall portion 13. Note that, in the description of this specification, the obliquely wound coil springs 20 arranged along the bottom wall portion 12 are written as “first obliquely wound coil springs 20A” and the obliquely wound coil springs 20 arranged along the ceiling wall portion 13 are written as “second obliquely wound coil springs 20B” when the obliquely wound coil springs 20 arranged along the bottom wall portion 12 and those arranged along the ceiling wall portion 13 are distinguished from each other, whereas no suffix is added to the reference sign of the obliquely wound coil springs when the obliquely wound coil springs 20 are collectively termed without being distinguished.

Each of the four holding shafts 30 is a round bar made of metal and, as shown in FIGS. 1 and 5, penetrates through the inside of the corresponding one of the four obliquely wound coil springs 20 with one end fixed to the first side wall portion 14 and the other end fixed to the second side wall portion 15. As shown in FIG. 5, each of two holding shafts 30 holding two first obliquely wound coil springs 20A is so arranged that a clearance to the bottom wall portion 12 is substantially equal to an outer diameter of the wire material 21 constituting the first obliquely wound coil spring 20A, and the first obliquely wound coil spring 20A is held in contact with the bottom wall portion 12. In this way, the first obliquely wound coil spring 20A is electrically connected to the terminal body 10. Similarly, each of two holding shafts 30 holding two second obliquely wound coil springs 20B is so arranged that a clearance to the ceiling wall portion 13 is substantially equal to the outer diameter of the wire material 21 constituting the second obliquely wound coil spring 20B, and the second obliquely wound coil spring 20B is held in contact with the ceiling wall portion 13. In this way, the second obliquely wound coil spring 20B is electrically connected to the terminal body 10.

As shown in FIG. 5, the first obliquely wound coil spring 20A is such that the wire material 21 is inclined to approach the second side wall portion 15 from the first side wall portion 14 (from a left-lower side to a right-upper side of FIG. 5) with distance from the bottom wall portion 12. Further, the second obliquely wound coil spring 20B is such that the wire material 21 is inclined to approach the second side wall portion 15 from the first side wall portion 14 (from a left-upper side to a right-lower side of FIG. 5) with distance from the ceiling wall portion 13.

A distance between the bottom wall portion 12 and the ceiling wall portion 13 is smaller than the sum of heights (dimensions in the direction perpendicular to the coil axes A) of the first and second obliquely wound coil springs 20A, 20B in a free state where no load is applied and the thickness of the tab portion T. A distance between the obliquely wound coil springs 20A, 20B facing each other is smaller than the thickness of the tab portion T in a state where the tab portion T is not inserted in the rectangular tube portion 11 and no load is applied to the obliquely wound coil springs 20A, 20B.

In connecting the male terminal fitting and the female terminal fitting 1, the tab portion T is caused to enter the rectangular tube portion 11 through the insertion slit 16 (in a direction indicated by an arrow in FIG. 1) by being slid in parallel to the bottom wall portion 12 and the ceiling wall portion 13. The tab portion T is inserted into the clearance between the first and second obliquely wound coil springs 20A, 20B and moves toward the second side wall portion 15 while pressing the first and second obliquely wound coil springs 20A, 20B.

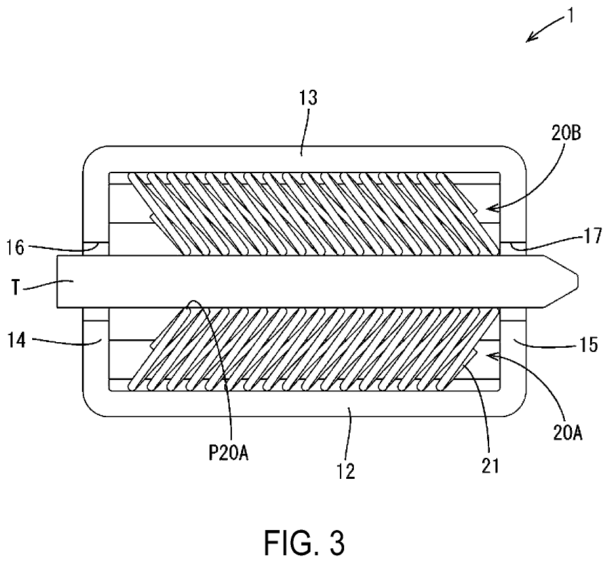

As the tab portion T moves toward the second side wall portion 15, a force acts to push arbitrary contact points P20A (see FIG. 3) of the first obliquely wound coil springs 20A with the tab portion T in a direction from the first side wall portion 14 toward the second side wall portion 15. Here, as described above, the wire material 21 is inclined to approach the second side wall portion 15 from the first side wall portion 14 with distance from the bottom wall portion 12 in the first obliquely wound coil spring 20A. Thus, the first obliquely wound coil spring 20A is tilted by a pressing force from the tab portion T and deformed to reduce the spring height (dimension in the direction perpendicular to the coil axis A). The same holds true also for the second obliquely wound coil springs 20B. In this way, the tab portion T can be inserted with a low insertion force.

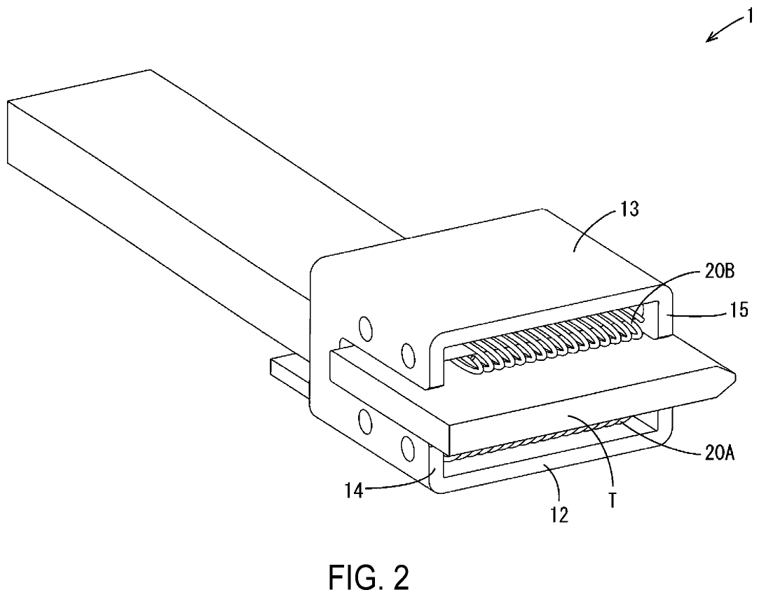

With the tab portion T inserted to a proper position (position shown in FIGS. 2 and 3) with respect to the female terminal fitting 1, the first obliquely wound coil springs 20A are sandwiched between the tab portion T and the bottom wall portion 12 and the second obliquely wound coil springs 20B are sandwiched between the tab portion T and the ceiling wall portion 13. By the insertion of the tab portion T, the first obliquely wound coil springs 20A are deformed to reduce the spring height (dimension in the direction perpendicular to the coil axes A). By resilient restoring forces of the first obliquely wound coil springs 20A, the first obliquely wound coil springs 20A are in contact with the tab portion T and the bottom wall portion 12 with a constant contact pressure. Similarly, the second obliquely wound coil springs 20B are also in contact with the tab portion T and the ceiling wall portion 13 with a constant contact pressure. In this way, the female terminal fitting 1 and the male terminal fitting are electrically connected.

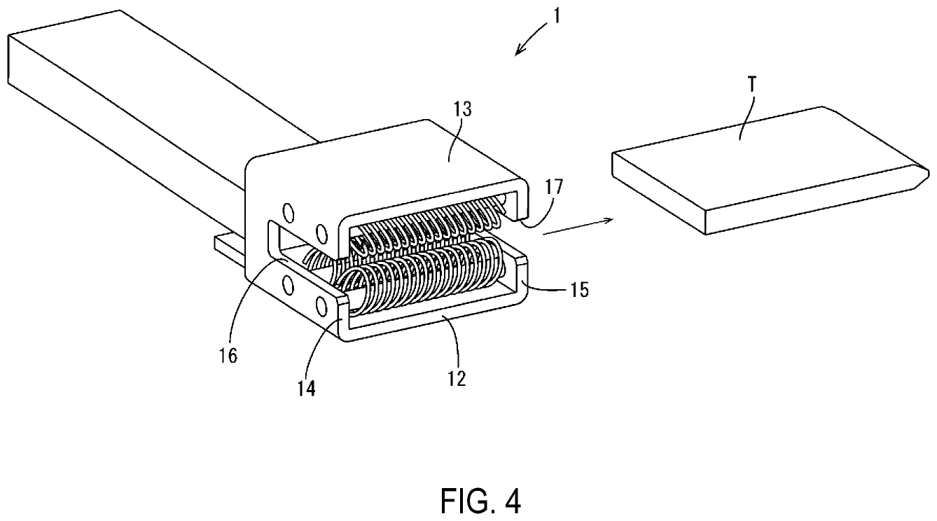

In separating the male terminal fitting from the female terminal fitting 1, the tab portion T is withdrawn to the outside of the rectangular tube portion 11 through the withdrawal slit 17 (in a direction indicated by an arrow in FIG. 4) by being slid in parallel to the bottom wall portion 17 and the ceiling wall portion 13. At this time, similarly when the tab portion T is caused to enter the rectangular tube portion 11, a force acts to push the contact points P20A of the first obliquely wound coil springs 20A with the tab portion T in the direction from the first side wall portion 14 toward the second side wall portion 15. Specifically, a force acts from the tab portion T in such a direction that the first obliquely wound coil springs 20A are tilted to reduce the spring height (dimension in the direction perpendicular to the coil axis A). The same holds true also for the second obliquely wound coil springs 20B. In this way, the tab portion T can be withdrawn with a low withdrawal force.

If the tab portion T is going to move toward the first side wall portion 14 (i.e. in a direction to be withdrawn through the insertion slit 16), a force acts to push the contact points P20A of the first obliquely wound coil springs 20A with the tab portion T toward the first side wall portion 14. Here, as described above, the wire material 21 is inclined to approach the second side wall portion 15 from the first side wall portion 14 with distance from the bottom wall portion 12 in the first obliquely wound coil springs 20A. Thus, the first obliquely wound coil springs 20A hold on to be deformed to rise with respect to the coil axes A by a pressing force from the tab portion T. The same holds true also for the second obliquely wound coil springs 20B. Thus, separation resistance to the tab portion T increases and the tab portion T is less likely to be withdrawn to outside through the insertion slit 16. As just described, inserting and withdrawing directions of the tab portion T into and from the female terminal fitting 1 are restricted to be one direction (direction to enter from the insertion slit 16 and exit from the withdrawal slit 17).

As described above, according to this embodiment, the female terminal fitting 1 is a terminal fitting to be connected to the flat plate-like tab portion T of the male terminal fitting and includes the rectangular tube portion 11 having the pair of side wall portions (first and second side wall portions 14, 15) arranged to face each other and the bottom wall portion 12 and the ceiling wall portion 13 coupling the pair of side wall portions and capable of accommodating the tab portion T inside, and the first and second obliquely wound coil springs 20A, 20B arranged inside the rectangular tube portion 11. The first obliquely wound coil springs 20A are arranged along the bottom wall portion 12 and electrically connected to the rectangular tube portion 11 and can resiliently contact the tab portion T accommodated inside the rectangular tube portion 11. The second obliquely wound coil springs 20B are arranged along the ceiling wall portion 13 and electrically connected to the rectangular tube portion 11 and can resiliently contact the tab portion T accommodated inside the rectangular tube portion 11. The first side wall portion 14 includes the insertion slit 16 through which the tab portion T is inserted into the rectangular tube portion 11, and the second side wall portion 15 includes the withdrawal slit 17 through which the tab portion T is withdrawn from the rectangular tube portion 11.

According to the above configuration, in connecting the male terminal fitting to the female terminal fitting 1, the tab portion T may be inserted into the rectangular tube portion 11 though the insertion slit 16 by being slid in parallel to the bottom wall portion 12 and the ceiling wall portion 13. Further, in separating the male terminal fitting from the female terminal fitting 1, the tab portion T may be withdrawn from the rectangular tube portion 11 though the withdrawal slit 17 by being similarly slid in parallel to the bottom wall portion 12 and the ceiling wall portion 13. Since the tab portion T can be easily inserted into and withdrawn from the female terminal fitting 1 by being slid in this way, a workload can be reduced also when a worker has to perform an operation in a somewhat uncomfortable posture such as when the worker gets under a vehicle body to perform an operation.

Further, the first obliquely wound coil springs 20A are so arranged that the coil axes A are perpendicular to the pair of side wall portions 14, 15 and the wire material 21 is inclined to approach the second side wall portion 15 from the first side wall portion 14 with distance from the bottom wall portion 12. Similarly, the second obliquely wound coil springs 20B are so arranged that the coil axes A are perpendicular to the pair of side wall portions 14, 15 and the wire material 21 is inclined to approach the second side wall portion 15 from the first side wall portion 14 with distance from the ceiling wall portion 13.

According to this configuration, in inserting the tab portion T into the rectangular tube portion 11 through the insertion slit 16, the obliquely wound coil springs 20A, 20B are tilted and deformed to reduce the spring height (dimension in the direction perpendicular to the coil axis A). In this way, the tab portion T can be inserted with a low insertion force. Also in withdrawing the tab portion T to the outside of the rectangular tube portion 11 through the withdrawal slit 17, a force acts from the tab portion T in a direction to deform the obliquely wound coil springs 20A, 20B to reduce the spring height (dimension in the direction perpendicular to the coil axes A). Thus, the tab portion T can be withdrawn with a low withdrawal force.

Further, the rectangular tube portion includes the bottom wall portion 12 and the ceiling wall portion 13 arranged to face each other and the first and second obliquely wound coil springs 20A, 20B.

According to this configuration, if the tab portion T is inserted into the female terminal fitting 1, the tab portion T is sandwiched by the first and second obliquely wound coil springs 20A, 20B. In this way, the obliquely wound coil springs 20A, 20B can be brought into contact with the tab portion T with a constant contact pressure and the reliability of electrical connection of the female terminal fitting 1 and the male terminal fitting can be enhanced.

### Second Embodiment

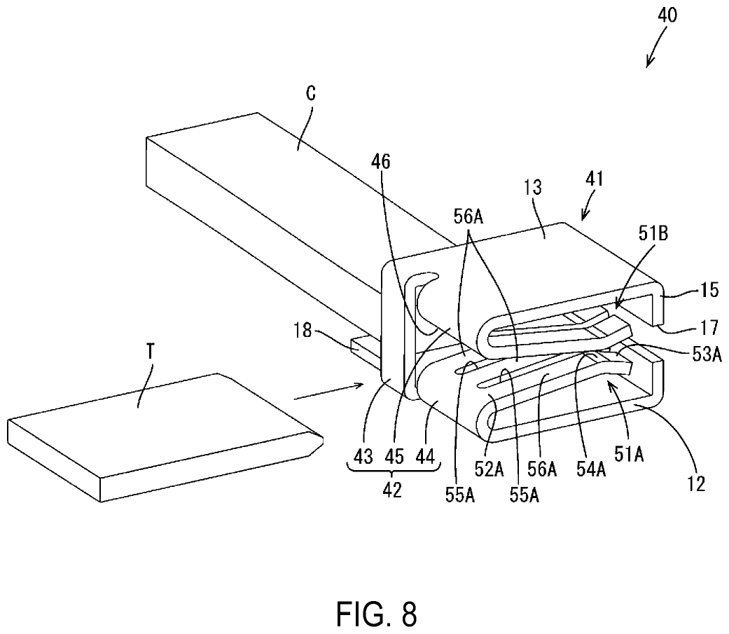

Next, a second embodiment is described with reference to FIGS. 8 to 12. A female terminal fitting 40 of this embodiment differs from that of the first embodiment in including resilient contact pieces 51A, 51B in the form of leaf springs instead of the obliquely wound coil springs 20.

The female terminal fitting 40 is made of metal and includes, as shown in FIG. 8, a rectangular tube portion 41 for receiving a tab portion T of a male terminal fitting inside, a wire connecting portion 18 continuous from this rectangular tube portion 41 and a pair of resilient contact pieces (first and second resilient contact pieces 51A, 51B) arranged inside the rectangular tube portion 41. In the following description, components similar to those of the first embodiment are denoted by the same reference signs and not described. As in the first embodiment, only the tab portion T is schematically shown for the male terminal fitting with other parts omitted in FIGS. 8 to 11.

As shown in FIG. 8, the rectangular tube portion 41 is a part having a rectangular tube shape open on both ends, and includes a bottom wall portion 12, a ceiling wall portion 13 and a pair of side wall portions (first side wall portion 42 and second side wall portion 15). The bottom wall portion 12, the ceiling wall portion 13 and the second side wall portion 15 are configured similarly to those of the first embodiment. The second side wall portion 15 includes a withdrawal slit 17. The withdrawal slit 17 is arranged at a middle position between the bottom wall portion 12 and the ceiling wall portion 13 and extends from one opening edge (opening edge on a front side of FIG. 8) of the rectangular tube portion 41 to the vicinity of the other opening edge (opening edge on a back side of FIG. 8).

As shown in FIG. 8, the first side wall portion 42 is arranged to face the second side wall portion 15 and composed of a straight wall portion 43 and a pair of curved portions (first and second curved portions 44, 45). The straight wall portion 43 is a strip-like wall portion partially linking the bottom wall portion 12 and the ceiling wall portion 13, and arranged adjacent to the other opening edge (opening edge on the back side of FIG. 8) of the rectangular tube portion 41. The first curved portion 44 is a wall portion extending from the bottom wall portion 12 and folded inwardly of the rectangular tube portion 41, and arranged between the one opening edge (opening edge on the front side of FIG. 8) of the rectangular tube portion 41 and the straight wall portion 43. The second curved portion 45 is a wall portion extending from the ceiling wall portion 13 and folded inwardly of the rectangular tube portion 41, and arranged between the one opening edge of the rectangular tube portion 41 and the straight wall portion 43. A clearance between the two curved portions 44, 45 serves as an insertion opening 46, which is an entrance for the tab portion T.

As shown in FIG. 8, the first resilient contact piece 51A is a leaf spring-like part continuous from the first curved portion 44 and extending toward the second side wall portion 15. One end of this first resilient contact piece 51A continuous from the first curved portion 44 serves as a base end portion 52A, and the other end serves as a free end portion 53A. The first resilient contact piece 51A has such a chevron shape that a most part near the base end portion 52A is gently separated from the bottom wall portion 12 with distance from the base end portion 52A and a remaining part near the free end portion 53A approaches the bottom wall portion 12 toward the free end portion 53A. A tip part of the chevron shape serves as a contact portion 54A to be brought into contact with the tab portion T. The first resilient contact piece 51A includes two dividing slits 55A, 55A extending from the free end portion 53A toward the base end portion 52A, and is divided into three spring pieces 56A, 56A, 56A by these dividing slits 55A, 55A.

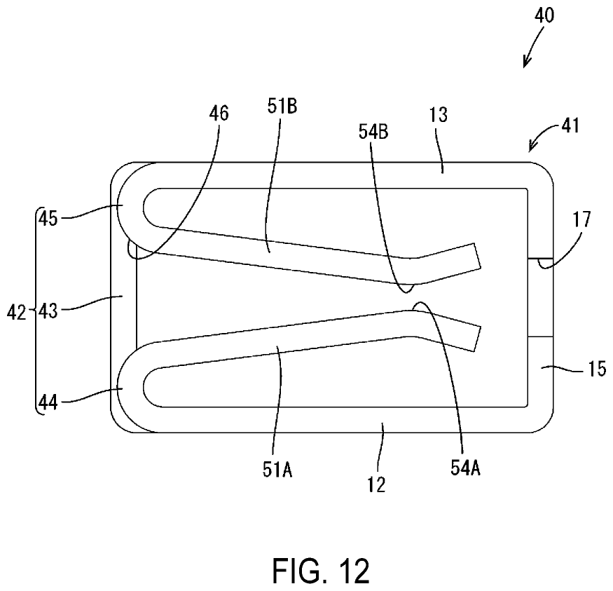

The second resilient contact piece 51B is a leaf spring-like part continuous from the second curved portion 45 and extending toward the second side wall portion 15. Since the second resilient contact piece 51B is shaped similarly to the first resilient contact piece 51A, the same components are denoted by the same reference signs with a suffix A for the first resilient contact piece 51A replaced by a suffix B, and not described. The first and second resilient contact pieces 51A, 51B are arranged to be convex to each other (see also FIG. 12), and the tab portion T can be sandwiched and held by the contact portions 54A, 54B. In a free state where the tab portion T is not inserted in the rectangular tube portion 41 and no load is applied to the two resilient contact pieces 51A, 51B, a distance between a pair of the contact portions 54A, 54B is smaller than a thickness of the tab portion T.

In connecting the male terminal fitting and the female terminal fitting 40, the tab portion T is caused to enter the rectangular tube portion 41 through the insertion opening 46 (in a direction indicated by an arrow in FIG. 8) by being slid in parallel to the bottom wall portion 12 and the ceiling wall portion 13. The tab portion T is inserted into between the two resilient contact pieces 51A, 51B and moves toward the second side wall portion 15.

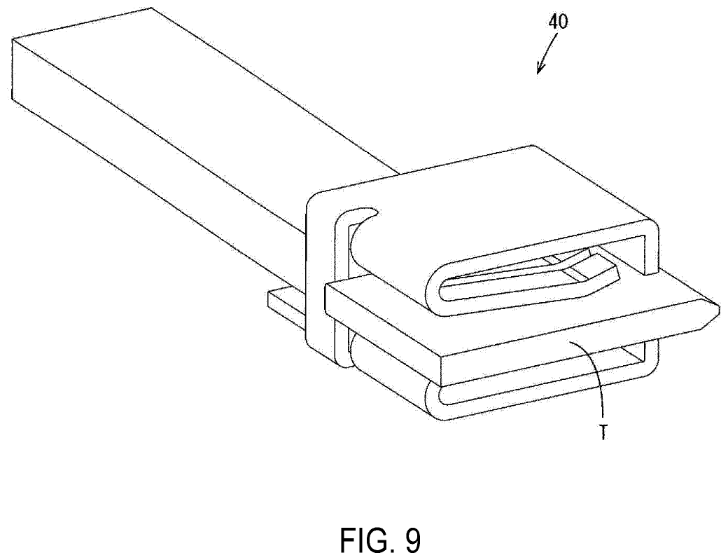

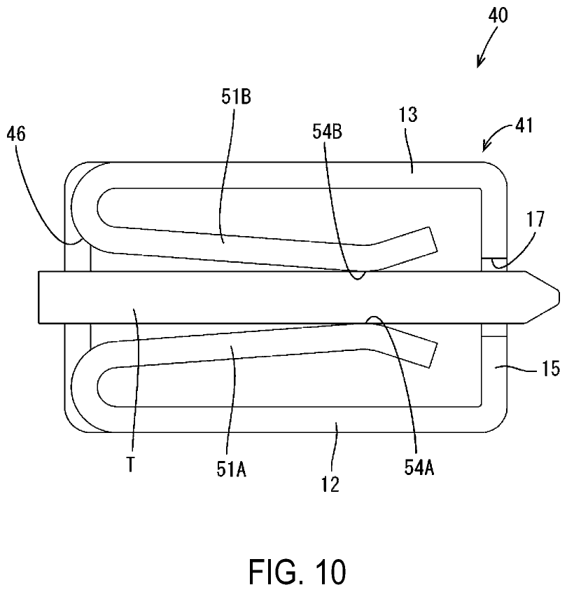

With the male terminal fitting inserted to a proper position (position shown in FIGS. 9 and 10) with respect to the female terminal fitting 40, the tab portion T is in contact with the contact portions 54A, 54B as shown in FIG. 10. The first and second resilient contact pieces 51A, 51B are respectively deflected to approach the bottom wall portion 12 and the ceiling wall portion 13. Then, the tab portion T is sandwiched between the contact portions 54A, 54B by resilient restoring forces from the resilient contact pieces 51A, 51B and held in contact with the resilient contact pieces 51A, 51B with a constant contact pressure. In this way, the female terminal fitting 40 and the male terminal fitting are electrically connected.

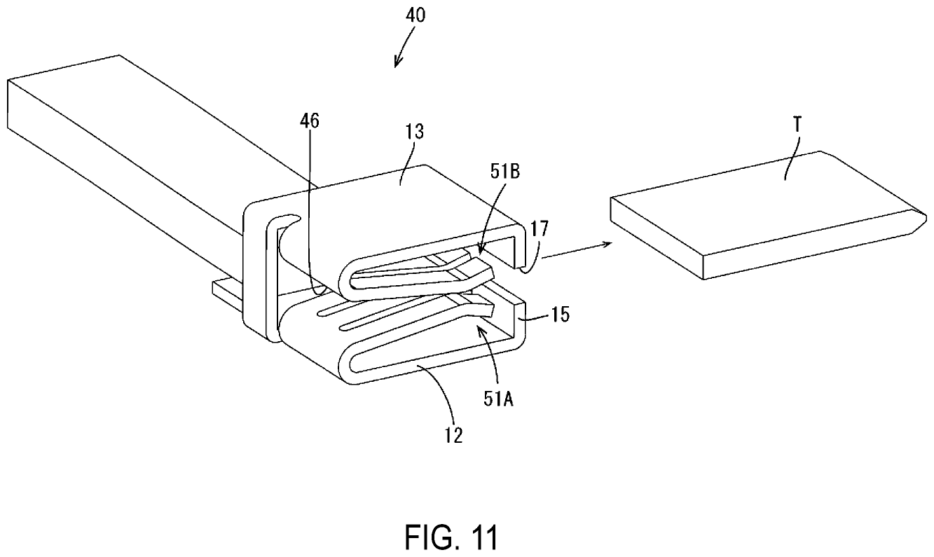

In separating the male terminal fitting from the female terminal fitting 40, the tab portion T is withdrawn to the outside of the rectangular tube portion 11 through the withdrawal slit 17 (in a direction indicated by an arrow in FIG. 11) by being slid in parallel to the bottom wall portion 12 and the ceiling wall portion 13.

As described above, according to this embodiment, the female terminal fitting 40 is a terminal fitting to be connected to the flat plate-like tab portion T of the male terminal fitting and includes the rectangular tube portion 41 having the pair of side wall portions (first and second side wall portions 42, 15) arranged to face each other and the bottom wall portion 12 and the ceiling wall portion 13 coupling the pair of side wall portions 42, 15 and capable of accommodating the tab portion T inside, and the first and second resilient contact pieces 51A, 51B arranged inside the rectangular tube portion 41. The first resilient contact piece 51A is arranged along the bottom wall portion 12 and electrically connected to the bottom wall portion 12 and can resiliently contact the tab portion T accommodated inside the rectangular tube portion 41. The second resilient contact piece 51B is arranged along the ceiling wall portion 13 and electrically connected to the ceiling wall portion 13 and can resiliently contact the tab portion T accommodated inside the rectangular tube portion 41. The first side wall portion 42 includes the insertion slit 16 through which the tab portion T is inserted into the rectangular tube portion 41, and the second side wall portion 15 includes the withdrawal slit 17 through which the tab portion T is withdrawn from the rectangular tube portion 41.

According to the above configuration, as in the first embodiment, the tab portion T may be inserted into the rectangular tube portion 41 though the insertion slit 16 by being slid in parallel to the bottom wall portion 12 and the ceiling wall portion 13 in connecting the male terminal fitting to the female terminal fitting 40. Further, in separating the male terminal fitting from the female terminal fitting 40, the tab portion T may be withdrawn from the rectangular tube portion 41 though the withdrawal slit 17 by being similarly slid in parallel to the bottom wall portion 12 and the ceiling wall portion 13. Since the tab portion T can be easily inserted into and withdrawn from the female terminal fitting 40 by being slid in this way, a workload can be reduced also when a worker has to perform an operation in a somewhat uncomfortable posture such as when the worker gets under a vehicle body to perform an operation.

Further, the rectangular tube portion 41 includes the bottom wall portion 12 and the ceiling wall portion 13 arranged to face each other and the first and second resilient contact pieces 51A, 51B.

According to this configuration, if the tab portion T is inserted into the female terminal fitting 40, the tab portion T is sandwiched by the first and second resilient contact pieces 51A, 51B. In this way, the resilient contact pieces 51A, 51B can be brought into contact with the tab portion T with a constant contact pressure and the reliability of electrical connection of the female terminal fitting 40 and the male terminal fitting can be enhanced.

### Other Embodiments

The technique disclosed by this specification is not limited to the above described and illustrated embodiments. For example, the following various modes are also included.

(1) The female terminal fitting 1 includes the bottom wall portion 12, the ceiling wall portion 13 and the first and second obliquely wound coil springs 20A, 20B in the above first embodiment, and the female terminal fitting 40 includes the bottom wall portion 12, the ceiling wall portion 13 and the first and second resilient contact pieces 51A, 51B in the above second embodiment. However, a body portion may include one coupling wall portion (coupling wall) and a contact portion (contact) arranged along the coupling wall portion may contact only one surface of a mating terminal.

(2) Although the female terminal fitting 1 includes two first obliquely wound coil springs 20A arranged along the bottom wall portion 12 in the above first embodiment, one, three or more first obliquely wound coil springs 20A may be arranged. The same holds true also for the second obliquely wound coil springs.

(3) The body portion may include a rotation restricting portion for restricting the rotation of obliquely wound coil springs about coil axes.

1. A terminal fitting to be connected to a mating terminal in a form of a flat plate, the terminal fitting comprising:
a body including a pair of side walls arranged to face each other and a coupling wall coupling the pair of side walls and capable of accommodating the mating terminal inside; and
an obliquely wound coil spring arranged along the coupling wall inside the body, electrically connected to the body and configured to resiliently contact the mating terminal accommodated inside the body, wherein:
one side wall of the pair of side walls includes an insertion opening, the mating terminal being inserted into the body through the insertion opening, and the other side wall of the pair of side walls includes a withdrawal opening, the mating terminal being withdrawn from the body through the withdrawal opening,
the obliquely wound coil spring is in the form of a coil formed by winding a conductive wire material about a coil axis a plurality of times and a straight line connecting an arbitrary first point of the wire material and a second point distant from the first point by a half circumference and a straight line connecting the second point and a third point distant from the second point by a half circumference are inclined toward a same side with respect to the coil axis, and
the obliquely wound coil spring is arranged such that an axis line is perpendicular to the pair of side walls and the wire material is inclined in a direction to approach the other side wall from the one side wall with distance from the coupling wall.

2. The terminal fitting of claim 1, wherein:
the obliquely wound coil spring is arranged in contact with the coupling wall in such an orientation that the axis line is parallel to the coupling wall.

3-4. (canceled)

5. The terminal fitting of claim 1, wherein the body includes a pair of the coupling walls and a pair of the obliquely wound coil springs arranged to face each other.
